(19) United States
(12) Patent Application Publication
(10) Pub. No.: US 2009/0280305 A1
(43) Pub. Date: Nov. 12, 2009

(54) TRANSPARENT SUBSTRATE WITH ELECTROMAGNETIC WAVE SHIELDING FILM, METHOD OF PRODUCING THE SAME, AND APPARATUS FOR PRODUCING THE SAME

(75) Inventors: Masaaki Ishikawa, Tokyo (JP); Tsunehiro Kobayashi, Tokyo (JP)

Correspondence Address: MERCHANT & GOULD PC, P.O. BOX 2903, MINNEAPOLIS, MN, 55402-0903, US

(73) Assignee: Sumitomo Osaka Cement Co., Ltd., Chiyoda-ku, Tokyo (JP)

(21) Appl. No.: 12/296,512

(22) PCT Filed: Apr. 9, 2007
(86) PCT No.: PCT/JP2007/057834

§ 371 Date: Oct. 8, 2008

(30) Foreign Application Priority Data
Apr. 10, 2006 (JP) 2006-107548

(51) Int. Cl. B32B 3/00; B05D 5/12; B41F 13/00

(52) U.S. Cl. 428/201; 427/256; 101/212

(57) ABSTRACT

The transparent substrate with an electromagnetic wave-shielding film of the present invention includes: a primer layer 2; a catalyst ink layer 3 having a predetermined pattern; and a metal layer 4 having the same shape as the pattern that are laminated in this order on a transparent substrate 1 having flexibility. The catalyst ink layer 3 is an ink layer where the catalyst ink is transferred on the primer layer 2 by pushing the primer layer 2 on the transparent substrate 1 against a catalyst ink on a printing cylinder for gravure printing.

### TECHNICAL FIELD

The present invention relates to a transparent substrate with an electromagnetic wave-shielding film, a method of producing the same, and an apparatus for producing the same.

This application claims the priority benefit of Japanese Patent Application No. 2006-107548, filed on Apr. 10, 2006.

### BACKGROUND ART

In recent years, a demand for transparent substrates with an electromagnetic wave-shielding film is increasing, and various types thereof have been developed.

As an example of transparent substrates with an electromagnetic wave-shielding film used in conventional displays such as CRT, the following transparent substrate can be mentioned. That is, an electromagnetic wave-shielding film is formed on a transparent substrate of, for example, a polyethlene terephthalate (PET) film, etc. by use of a sputtering method or the like to produce a conventional transparent substrate with an electromagnetic wave-shielding film. A sputter film such as an indium tin oxide (ITO) film or a silver film formed by the sputtering method is adopted in such an electromagnetic wave-shielding film.

In typical flat panel displays (FPD) such as plasma display panels (PDP used in a large-size display that have recently attracted a great deal of attention), a higher capability to shield against electromagnetic waves is required. Accordingly, an etching mesh film wherein a copper foil formed on a transparent film is formed into a grid-like pattern by photolithography is mainly used therein.

It is preferable that the front side, lateral sides and backside of the above-described mesh film be black in terms of image contrast. However, in a conventional method of producing an etching mesh film, a copper foil is etched to from a pattern. Because of this, it is difficult to blacken all of the front side, the lateral sides (in the longitudinal direction and in the lateral direction) and the backside (i.e. four sides). In particular, it is difficult to color the lateral sides. Consequently, there is a problem in which such a mesh film deteriorates the image contrast when a display is equipped with the mesh film. Therefore, in order to blacken each side, a method wherein the copper surface of the etching mesh film is oxidized to black is mainly used. However, in such a method, there is a problem, for example, in which the surface electrical resistance of the etching mesh film is increased.

Additionally, many production processes are required in the production of an etching mesh film, and it is difficult to control the conditions for etching. Consequently, the yield is insufficient, among others, and this results in a problem of high cost. In particular, in order to popularize typical flat displays as electrical household appliance, a reduction in the total cost is required, including production costs. Accordingly, a reduction in the price is sought in electromagnetic wave shielding film used in flat panel displays.

Against the above-describe background, as a method of producing an electromagnetic wave shielding film having higher conductivity and transparency at a lower cost, a method wherein a paste containing a precious metal catalyst is printed onto a transparent film by the screen printing method to form an underlying layer having a fine pattern, and copper is deposited on the underlying layer by electroless deposition is proposed (for example, see Patent Document 1 or 2). However, such a method has problems described below. Therefore, further improvements has been sought in the art.

Patent Document 1: Japanese Unexamined Patent Application, Publication No. H11-170420.

Patent Document 2: Japanese Unexamined Patent Application, Publication No. 2003-145709.

### DISCLOSURE OF THE INVENTION

In conventional electromagnetic wave shielding films obtained by the screen printing method, there is a problem wherein the accuracy of a printed pattern, and the film thickness thereof are limited. Therefore, it is difficult to achieve highly accurate patterning.

Furthermore, in conventional screen printing methods, electromagnetic wave shielding films can be easily produced at a low cost. However, the screen printing method is a type of sheet-fed printing. Therefore, its printing speed is limited, and there is a problem in which it is difficult to further improve the productivity.

The present invention was achieved to solve the above-described problems in the prior art. The object of the present invention is to provide a transparent substrate with an electromagnetic wave-shielding film, a method of producing the same, and an apparatus for producing the same where the transparent substrate has high electric conductivity and excellent transparency, and highly accurate patterning can be achieved by a short and cost-effective process. The present inventors conducted intensive studies on development of such a transparent substrate with an electromagnetic wave-shielding film having high electric conductivity and excellent transparency, wherein highly accurate patterning can be achieved by a short and cost-effective process. This resulted in the present invention.

Specifically, the present inventors adopted a gravure printing method as the printing method used therein. The present inventors discovered that an underlying layer on the transparent substrate was pressed against a catalyst ink on a printing cylinder for gravure printing for a predetermined time, whereby an electromagnetic wave-shielding film wherein a high resolution patterning is achieved, can be formed on the transparent substrate at a low cost. This resulted in the present invention.

More specifically, an aspect of the present invention is to provide a transparent substrate with an electromagnetic wave-shielding film, including an underlying layer, a catalyst ink layer having a predetermined pattern, and a metal layer having the same shape as the pattern that are laminated in this order on the transparent substrate having flexibility, wherein the catalyst ink layer is an ink layer where the catalyst ink is transferred on the underlying layer by pushing the underlying layer on the transparent substrate against a catalyst ink on a printing cylinder for gravure printing.

Another aspect of the present invention is to provide a method of producing a transparent substrate with an electromagnetic wave-shielding film, the method including: coating a catalyst ink onto a printing cylinder for gravure printing where a predetermined pattern is formed; keeping the catalyst ink on the printing cylinder being pressed against an underlying layer formed on a transparent film having flexibility for a predetermined time; after pressing, separating the transparent substrate from the printing cylinder to transfer the catalyst ink on the printing cylinder onto the underlying layer on the transparent substrate; and providing on the catalyst ink layer having a predetermined pattern a metal layer having the same shape as the pattern to produce the transparent substrate with an electromagnetic wave-shielding film, including the underlying layer, the catalyst ink layer having the predetermined pattern, and the metal layer having the same shape as the pattern that are laminated in this order on the transparent substrate having flexibility.

Yet another aspect of the present invention is to provide An apparatus for producing a transparent substrate with an electromagnetic wave-shielding film which is an apparatus for producing a transparent substrate with an electromagnetic wave-shielding film, including an underlying layer, a catalyst ink layer having a predetermined pattern, and a metal layer having the same shape as the pattern that are laminated in this order on a transparent substrate having flexibility, the apparatus including: a printing cylinder for gravure printing having a predetermined pattern groove on the surface; a dispenser that coats a catalyst ink onto the printing cylinder; a blade that removes an unnecessary portion of the ink other than the ink included inside the pattern groove with respect to the coated catalyst ink; a device that keeps the underlying layer on the transparent substrate being pressed against the printing cylinder, in which the catalyst ink is included in the pattern groove, for a predetermined time; and a device which separates the transparent substrate from the printing cylinder after pressing to transfer the catalyst ink onto the underlying layer.

In the present invention, the device that keeps the underlying layer on the transparent substrate being pressed against the printing cylinder, in which the catalyst ink is included in the pattern groove, for a predetermined time may be the device which separates the transparent substrate from the printing cylinder after pressing to transfer the catalyst ink onto the underlying layer.

According to the transparent substrate with an electromagnetic wave-shielding film of the present invention, the underlying layer on the transparent substrate is pressed against the catalyst ink on the printing cylinder for gravure printing for a predetermined time to transfer the catalyst ink onto the underlying layer. Therefore, the pattern of the catalyst ink layer can be formed into a high-resolution pattern. Consequently, the pattern resolution of the electromagnetic wave-shielding film can be made high.

Because of this, the present invention can easily achieve a transparent substrate with an electromagnetic wave-shielding film having high electric conductivity, excellent transparency and a high-resolution pattern.

According to the method of producing a transparent substrate with an electromagnetic wave-shielding film of the present invention, the underlying layer formed on the transparent substrate is pressed against the catalyst ink of a predetermined pattern on the printing cylinder, and these are maintained in the state for a predetermined time. Then, the transparent substrate is separated from the printing cylinder to transfer the catalyst ink on the printing cylinder onto the underlying layer on the transparent substrate. Therefore, high-resolution patterning can be conducted to the electromagnetic wave-shielding film in a short and cost-effective process.

That is, a transparent substrate with an electromagnetic wave-shielding film having high electric conductivity, excellent transparency and a high-resolution pattern can be produced in a short and cost-effective process.

According to the apparatus for producing a transparent substrate with an electromagnetic wave-shielding film of the present invention, the apparatus includes a printing cylinder for gravure printing having a predetermined pattern; a dispenser that coats a catalyst ink onto the printing cylinder; and a blade that removes the unnecessary part of the coated catalyst ink. Furthermore, in the apparatus, the underlying layer formed on the transparent substrate is pressed against the printing cylinder, and these are maintained in the state for a predetermined time. Then, the transparent substrate is separated from the printing cylinder to transfer the catalyst ink onto the underlying layer. Accordingly, a transparent substrate with an electromagnetic wave-shielding film having high electric conductivity, excellent transparency and a high-resolution pattern can be produced in a short and cost-effective process using the apparatus having a simple configuration.

### BRIEF DESCRIPTION OF THE DRAWINGS

FIG. 1 is a plan view showing an example of the transparent substrate with an electromagnetic wave-shielding film of the present invention.

FIG. 2 is an enlarged cross-section with respect to a portion of the example of the transparent substrate with an electromagnetic wave-shielding film of the present invention.

FIG. 3 is a schematic diagram showing an example of the apparatus for producing a transparent substrate with an electromagnetic wave-shielding film of the present invention.

FIG. 4 is a schematic diagram showing another example of the apparatus for producing a transparent substrate with an electromagnetic wave-shielding film of the present invention.

In figures, reference numeral “1” refers to a transparent film; reference numeral “2” refers a primer layer; reference numeral “3” refers to a catalyst layer; reference numeral “4” refers to a metal layer; reference numeral “11” refers to a printing cylinder; reference numeral “12” refers to a pattern groove; reference numeral “13” refers to a dispenser; reference numeral “14” refers to a blade; reference numerals “15” and “16” refer to a backup roll; symbol “C” refers to a catalyst ink; symbol “f” refers to a transparent film for gravure printing; symbol “S” refers to a space between lines; and symbol “L” refers to a width of the line.

### BEST MODE FOR CARRYING OUT THE INVENTION

Hereinafter, the best mode for carrying out the transparent substrate with an electromagnetic wave-shielding film, the method of producing the same, and the production apparatus of the present invention will be described.

The embodiment is specifically given below to facilitate better understanding of the scope of the present invention, and the present invention is not limited to the described embodiment unless otherwise specified.

The transparent substrate with an electromagnetic wave-shielding film, the method of producing the same, and the production apparatus of the present invention specifically relate to a transparent substrate with an electromagnetic wave-shielding film that has high electric conductivity and excellent transparency, and that is preferably applied to a flat panel display (FPD) such as a plasma display panel (PDP); and a production method and a production apparatus thereof that enable high-resolution patterning in a short and cost-effective process.

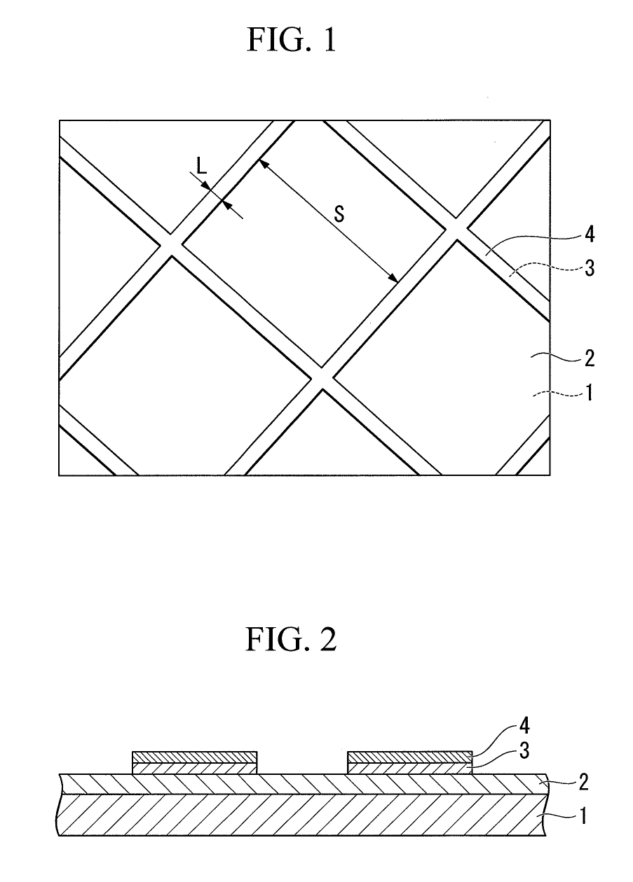

The transparent film with an electromagnetic wave-shielding film is described with reference to FIGS. 1 and 2 below.

FIG. 1 is a plan view showing an example of the transparent film with an electromagnetic wave-shielding film of the present invention, and FIG. 2 is an enlarged cross-section thereof. In the figures, reference numeral “1” refers to a transparent film (transparent substrate) having flexibility (such as polyethylene terephthalate (PET)); reference numeral “2” refers to a primer layer (underlying layer) formed on a whole area of the top surface of transparent film 1; reference numeral “3” refers to a catalyst ink layer formed into a predetermined pattern on the primer layer 2 by a gravure printing method; and reference numeral “4” refers to a metal layer that has the same shape as the pattern and that is formed on the catalyst ink layer 3 by a plating method. In the present invention, the electromagnetic wave-shielding film means a combination of the catalyst ink layer and the metal layer.

With regard to the catalyst ink layer 3, the primer layer 2 on the transparent film 1 is pressed against the catalyst ink on the printing cylinder for gravure printing whereby the catalyst ink is transferred onto the primer layer 2 to form the catalyst ink layer 3. The pattern shape of the catalyst ink layer 3 and the metal layer 4 can be appropriately selected according to necessity, and any shape can be adopted as long as the shape can achieve electromagnetic wave shielding. For example, a grid pattern can be mentioned, and its line width and a space between lines can also be selected according to necessity. For example, a grid pattern where the line width “L” is within a range of 5 μm to 100 μm, and the line interval “S” is within a range of 150 μm to 500 μm is preferably used. The number of lines, width or inclination of the grid pattern; the shape of the line; the number of pits, the shape thereof, or the size thereof, among others, may be modified where necessary. The shape may be a square, circle or other polygons. In addition, each condition of the pattern may be modified at the left, right, top and bottom sides where necessary. The present invention can also provide a transparent substrate with an electromagnetic wave-shielding film having a continuous pattern where nicks or joints are not present, and such a transparent substrate will be highly applicable and cost-effective. According to the production method of the present invention, any type of shape can be highly accurately formed, and therefore, any desired shape can be achieved.

The transparent film 1 is a film having flexibility. The transparent film 1 is not particularly limited as long as the film can be applied to gravure printing. As materials for the transparent film, PET, PEN, and TAC can be used. These can be used singularly or in combination. Any polymers may be used; either a homopolymer or a copolymer may be adopted. The transparent film may be a monolayer or a lamination layer. The degree of flexibility of the film is not limited as long as it does not cause a problem. Additionally, the thickness of the film is not particularly limited as long as any problems are not caused. However, the thickness of the film is preferably within a range of 10 μm to 200 μm, and more preferably within a range of 30 μm to 150 μm. Because continuous processing can be conducted in the production method of the present invention, a long continuous transparent film can be used therein. Accordingly, the length or the width of the film is not particularly limited.

The primer layer 2 is formed of a composite material including fine particles of oxides and an organic polymer.

As examples of the fine particles of oxides, metal oxides such as alumina, titania or zirconia; or inorganic oxides such as silica can be mentioned. These can be used singularly or in combination.

The organic polymer is not particularly limited as long as the organic polymer is a resin that exhibits resistance to a plating bath for plating the metal layer 4, and can be selected according to necessity. For example, a resin having excellent chemical resistance and heat-resistant temperature of 120° C. to 150° C. can be used. Specifically, cellulose derivatives such as ethyl cellulose or propyl cellulose; polyvinyl butyral, an acrylic resin, a polyurethane resin, a rosin ester resin, etc. can be mentioned. These can be used singularly or in combination.

In particular, when a resin having flexibility such as a polyurethane resin is used, the primer layer itself has flexibility. Accordingly, when the catalyst ink is transferred from the printing cylinder onto the primer layer by the gravure printing method, the primer layer comes into contact with the pattern groove of the printing cylinder, the primer layer is pushed into the pattern groove, and this results in sufficient transfer properties. Therefore, use of such a resin having flexibility is preferable.

The ratio (M/R) of the oxide fine particles (M) to the organic polymer (R) is preferably within a range of 90/10 to 10/90, the more preferably within a range of 75/25 to 25/75, and most preferably within a range of 60/40 to 40/60 by weight ratio.

If the ratio of the oxide fine particles is equal to the upper limit of the above range or less, adhesion strength of the primer layer 2 to the transparent film 1 can be maintained, transparency of the produced transparent film with an electromagnetic wave-shielding film will not be deteriorated, and the haze thereof will also not be increased. On the other hand, when the ratio is equal to the lower limit of the above range or higher, adhesion strength of the primer layer 2 to the transparent film 1 can be maintained, its functions as a receptive layer for the catalyst ink layer can also be maintained when the catalyst ink layer is formed by a gravure printing method, thereby preventing the printed catalyst ink layer from dripping or effusing.

The thickness of the primer layer 2 is preferably within a range of 0.5 μm to 10 μm, more preferably within a range of 0.7 μm to 7 μm, and most preferably within a range of 1 μm to 3 μm.

When the thickness of the primer layer 2 is equal to the lower limit of the above range or higher, its functions as a receptive layer for the catalyst ink layer can also be maintained when the catalyst ink layer is formed by a gravure printing method. On the other hand, when the thickness of the primer layer 2 is equal to the upper limit of the above range or less, generation of cracks or the like in the printed catalyst ink layer can be prevented.

The catalyst ink layer 3 includes oxide fine particles carrying fine particles of a precious metal, a black pigment, and a composite material including an organic polymer.

The reason why fine oxide particles carrying fine particles of a precious metal are used therein is that thixotropy properties of the catalyst ink suitable for printing can be obtained, thereby obtaining a preferable printed shape, when fine particles of a precious metal are distributed therein.

The fine particles of a precious metal are not particularly limited. For example, fine particles of palladium, platinum, gold, among others, can be mentioned. These fine particles of a precious metal can be used singularly or in combination. The size and the shape of fine particles are not limited. For example, the fine particles may be formed into a spherical shape or thin film flakes. The diameter of the particles is preferably within a range of 5 nm to 500 nm, and more preferably within a range of 10 nm to 100 nm. The oxide fine particle carrying the fine particles of precious metals are not particularly limited. For example, fine particles of oxides such as alumina, zinc oxide, zirconia or titania can be mentioned. These fine particles of metal oxides may be used singularly or in combination of two or more types thereof. The size and the shape of the fine particles are not limited. The diameter of fine particles is preferably within a range of 5 nm to 500 nm, and more preferably within a range of 10 nm to 100 nm.

The ratio (N/M) of the fine particles of a precious metal (N) to the fine particles of an oxide (M) is preferably within a range of 0.5/99.5 to 5/95, and more preferably within a range of 1/99 to 2/98 by weight ratio. When the ratio of the fine particles of a precious metal is equal to the lower limit of the above range or higher, the fine particles of a precious metal will sufficiently function as a catalyst in electroless plating. On the other hand, when the ratio of the fine particles of a precious metal is equal to the upper limit of the above range or less, such a function of the fine particles of a precious metal as a catalyst in electroless plating will not be saturated. Therefore, use of an excessive amount of high-priced precious metals can be prevented, and an increase in costs can be prevented.

Examples of the black pigment include carbon black.

The organic polymer may be a resin that is suitable for gravure printing and that has resistance to an alkali electroless plating solution. For example, ethyl cellulose, a rosin ester-based resin, an acrylic resin, a polyvinyl butyral resin, a polyurethane resin can be mentioned. These resins can be used singularly or in combination.

The ratio (NM/R) of the fine particles of an oxide (NM) carrying fine particles of a precious metal to the organic polymer (R) is preferably within a range of 40/60 to 80/20, more preferably within a range of 50/50 to 80/20, and most preferably within a range of 60/40 to 70/30 by weight ratio. When the ratio of the fine particles of an oxide is equal to the lower limit of the above range or higher, all fine particles of a precious metal included therein are not covered by the polymer resin, and therefore, the fine particles sufficiently function as a catalyst in electroless plating. On the other hand, the ratio of the fine particles of an oxide is equal to the upper limit of the above range or less, printing properties will not be deteriorated, and curing of the printed film of the polymer resin is sufficient, thereby achieving sufficient adhesion properties to the transparent film.

The metal layer 4 imparts electric conductivity to the electromagnetic wave-shielding film. The structure of the metal layer may be arranged into a required structure according to necessity. For example, the metal layer may be formed into a monolayer structure of an electroless copper-plated layer or a nickel-plated layer; or may be formed into a two-layer structure where a black plated layer such as a black nickel-plated layer, black chromium-plated layer, or nickel-tin alloy-plated layer is formed on a copper-electroplated layer. In particular, a metal layer having a two-layer structure is preferable when it is required to produce an electromagnetic wave-shielding film having low resistance. The black plated layer can be blackened simultaneously with respect to the surface and the side planes, and its electric conductivity will not be lowered.

Hereinafter, the method of producing a transparent film with an electromagnetic wave-shielding film according to the present embodiment will be described.

### [Formation of Primer Layer]

A coating material for forming the primer layer is coated onto the transparent film 1 having flexibility such as polyethlene terephthalate (PET), and this is then dried to form the primer layer 2.

As the coating material for forming the primer layer, a coating material including fine particles of an oxide, an organic polymer, and an organic solvent can be preferably used.

Examples of the fine particles of an oxide include metal oxides such as alumina, titania or zirconia; inorganic oxides such as silica. These may be used in combination.

The amount of the fine particles of an oxide included therein is preferably within a range of 0.2% to 15% by mass, more preferably within a range of 0.5% to 12% by mass, and more preferably within a range of 1% to 8% by mass.

When the amount of the fine particles of an oxide is 0.2% by mass or more, the thickness of the primer layer 2 will not be excessively thin, and its function as a receptive layer will not be deteriorated when forming a catalyst ink layer thereon. On the other hand, when the amount of the fine particles of an oxide is 15% by mass or less, the thickness of the primer layer 2 will not be excessively thick, and cracks are hardly caused in the printed catalyst ink layer.

As the organic polymer, a resin that has resistance to a plating bath used for plating the metal layer 3 can be used. For example, a resin having a heat resistant temperature of 120° C. to 150° C. and excellent chemical resistance may be preferably used. Examples thereof include cellulose derivatives such as ethyl cellulose or propyl cellulose, polyvinyl butyral, an acrylic resin, a polyurethane resin, a rosin ester-based resin. These resins can be used singularly or in combination.

The amount of the organic polymer included therein is preferably within a range of 0.2% to 15% by weight, more preferably within a range of 0.5% to 12% by weight, and most preferably within a range of 1% to 8% by weight.

When the amount of the organic polymer is 0.2% by weight or more, the thickness of the primer layer 2 will not be excessively thin, and its function as a receptive layer will not be deteriorated when forming a catalyst ink layer thereon. On the other hand, when the amount of the organic polymer is 15% by weight or less, the thickness of the primer layer 2 will be excessively thick, and cracks are hardly caused in the printed catalyst ink layer.

In particular, if a resin having flexibility such as a polyurethane resin is used in the primer layer, the primer layer itself has flexibility. Accordingly, when the catalyst ink is transferred from the printing cylinder onto the primer layer by a gravure printing method, the primer layer can come into contact with the pattern groove on the printing cylinder as the layer continuously adheres to the groove, and the portion of a primer layer is pushed into the pattern groove, thereby achieving excellent transfer properties. Therefore, use of such a resin is preferable.

As the organic solvent, a solvent that enables dispersion of the fine particles of an oxide and that can dissolve the organic polymer may be preferably used. For example, hydrocarbons such as toluene or xylene, alicyclic hydrocarbons such as cyclohexanone, ketones such as methyl ethyl ketone, or alcohols such as isopropyl alcohol can be preferably used.

A phosphoester-based dispersing agent may be added to the organic solvent to further facilitate the dispersion of the fine particles of an oxide.

The thickness of the produced primer layer 2 is preferably within a range of 0.5 μm to 5.0 μm, more preferably within a range of 0.4 μm to 4.0 μm, and most preferably within a range of 1.0 μm to 3.0 μm. When the thickness of the primer layer 2 is the lower limit of the above range or higher, its function as a receptive layer can be maintained when forming a catalyst ink layer thereon by the gravure printing method. On the other hand, when the thickness of the primer layer 2 is the upper limit of the above range or less, cracks are hardly caused in the printed catalyst ink layer.

### [Formation of Catalyst Ink Layer]

A catalyst ink is coated onto the above-described primer layer 2 in a predetermined pattern by the gravure printing method. Then, this is dried to form a catalyst ink layer 3.

The catalyst ink is not limited, and an appropriate ink may be selected according to necessity as long as a problem does not arise. An ink containing fine particles of an oxide carrying fine particles of a precious metal; a black pigment; an organic polymer; and an organic solvent may be preferably used.

The fine particles of an oxide carrying fine particles of a precious metal are used therein to achieve thixotropy properties of the catalyst ink suitable for printing, thereby obtaining a preferable printed shape.

The amount of the fine particles of a precious metal is preferably within a range of 0.01% to 1.5% by weight, more preferably within a range of 0.05% to 1% by weight, and most preferably within a range of 0.10% to 0.50% by weight.

When the amount of the fine particles of a precious metal is 0.01% by weight or more, the fine particles of a precious metal can function as a catalyst for electroless plating. On the other hand, the amount of the fine particles of a precious metal is 1.5% by weight or less, the function thereof can be sufficiently obtained without using an excessive amount of such a precious metal, which is expensive, thereby preventing an increase in costs.

The amount of the fine particles of an oxide included therein is preferably within a range of 3.0% to 27.0% by weight, more preferably within a range of 8.0% to 23.0% by weight, and most preferably within a range of 13.0% to 20.0% by weight.

When the amount of the fine particles of an oxide is 3.0% by weight or more, viscosity of the catalyst ink hardly decreases or thixotropy properties thereof are hardly deteriorated. That is, the printed film is prevented from dripping, and the accuracy of printing is hardly lowered. On the other hand, when the amount of the fine particles of an oxide is 27.0% by weight or less, the viscosity of the catalyst ink will not be excessively increased. Accordingly, while removing the unnecessary portion of the ink with a blade, the ink can be completely removed, and little of the ink remains.

The black pigment can be appropriately selected according to necessity. For example, carbon black or the like can be preferably mentioned.

The amount of the black pigment included therein is preferably within a range of 0.03% to 3.0% by weight, more preferably within a range of 0.05% to 2.0% by weight, and most preferably within a range of 0.1% to 1.0% by weight.

When the amount of the black pigment is 0.03% by weight or more, the intensity of black coloration will be sufficient with respect to the mesh of the backside of the printed film. Accordingly, when the transparent substrate with an electromagnetic wave-shielding film is attached to a screen of a display such as PDP, an excellent contrast can be obtained. On the other hand, when the amount of the black pigment is 3.0% by weight or less, printing properties can be also retained while achieving sufficient intensity of black coloration with respect to the mesh of the backside of the printed film, and excellent contrast.

With regard to the organic polymer, a resin that is suitable for gravure printing and that has resistance to an alkali electroless plating solution can be used without any limitations. For example, ethyl cellulose, a rosin ester-based resin, an acrylic resin, a polyvinyl butyral resin, or a polyurethane resin can be mentioned. These resins can be used singularly or in combination. In particular, ethyl cellulose is preferable for gravure printing.

The amount of the organic polymer included therein is preferably within a range of 1.0% to 15.0% by weight, more preferably within a range of 3.0% to 12.0% by weight, and most preferably within a range of 6.0% to 10.0% by weight.

When the amount of the organic polymer is 1.0% by weight or more, the viscosity of the ink will not be excessively lowered and such an amount is suitable for printing. On the other hand, when the amount of the organic polymer is 15.0% by weight or less, the viscosity of the ink will not be excessively increased, and this is preferable for printing.

With regard to the organic solvent, a solvent that can dissolve the organic polymer and that is suitable for gravure printing may be used. For example, toluene, methyl ethyl ketone (MEK), methyl isobutyl ketone (MIBK), butyl acetate, cyclohexanone, butyl carbitol, butyl carbitol acetate, or α-terpineol can be mentioned.

The viscosity of the catalyst ink is preferably within a range of 1 to 500 Pa·S, more preferably within a range of 25 to 350 Pa·S, and most preferably within a range of 50 to 200 Pa·S.

When the viscosity of the catalyst ink is 1 Pa·S or more, thixotropy properties of the ink can be maintained, and defects such as cobwebbing hardly occur, thereby achieving an excellent printing shape. On the other hand, when the viscosity of the catalyst ink is 500 Pa·S or less, the ink can be uniformly supplied thereto while conducting gravure printing, and printing irregularities hardly occur.

Hereinafter, an example of a process of forming the catalyst ink layer will be described.

In the apparatus for producing a transparent substrate with an electromagnetic wave-shielding film of the present invention, a pushing and/or separating device may be provided in order to efficiently conduct pushing the transparent substrate onto the printing cylinder. For example, according to necessity, one or more rolls, preferably two or more rolls, and more preferably at least one pair of rolls can be provided parallel to the printing cylinder where there is a space between rolls with each other. By adjusting the pushing position of the roll, the time where the transparent substrate is pushed onto the printing cylinder can be preferably adjusted. The roll may be disposed where the roll is brought into contact with the printing cylinder or where there is a space between the roll and the printing cylinder. The position of the roll can be freely determined. The rolls may be disposed upstream or downstream of the transparent sheet across the printing cylinder. At least one of the rolls may be a device that facilitate separation of the sheet from the printing cylinder.

As described above, a pair of rolls for pushing the transparent substrate onto the printing cylinder may be provided in parallel to the printing cylinder where a space is provided between the roll and the printing cylinder, and the time where the transparent substrate is pushed onto the printing cylinder by adjusting the pushing position of each roll. Based on such a configuration, resolution of the pattern of the catalyst ink transferred onto the underlying layer can be further improved.

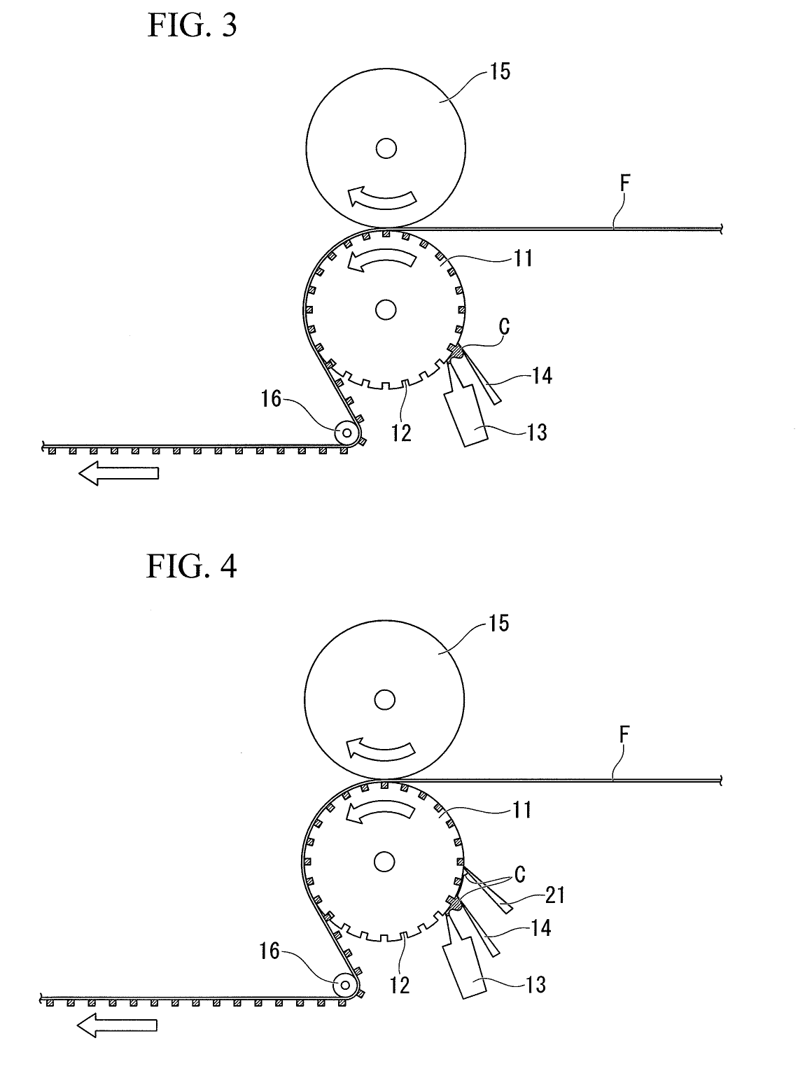

For example, transferring the catalyst ink layer 3 onto the primer layer 2 can be conducted by using the apparatus shown in FIG. 3.

This apparatus is used for forming a catalyst ink layer 3 having a predetermined pattern on the primer layer 2 of the transparent film 1 by gravure printing. In FIG. 3, reference numeral “11” refers to a printing cylinder for gravure printing (namely, a cylinder on which pattern grooves 12 are formed); reference numeral “13” refers to a dispenser that coats a catalyst ink “C” on the printing cylinder 11; reference numeral “14” refers to a blade that removes an unnecessary portion of the coated catalyst ink “C” other than the ink in pattern grooves 12; and reference numerals “15” and “16” refer to backup rolls that pushes a transparent film “F” for gravure printing, which is obtained by forming the primer layer 2 on one side of a transparent film 1, onto the printing cylinder 11 for a predetermined time. The diameter or width of the printing cylinder; the pattern shape thereof; or the depth or the cross-section shape of the groove may be appropriately selected according to necessity. For example, the depth of the groove is generally within a range of 1 μm to 50 μm, preferably within a range of 3 μm to 20 μm, and more preferably within a range of 5 μm to 15 μm. The depth of the groove may be uniform, but may be varied by position where necessary. The cross-sectional shape of the groove may be preferably formed into a square-like shape where the corner is curved; or a semicircular shape.

At first, in order to push the transparent film “F” onto the printing cylinder 11 for a predetermined time, the position of the backup roll 16 may be adjusted to retain a certain pushing time in accordance with the printing speed. The pushing time can be appropriately adjusted according to necessity. In general, the pushing time may be preferably within a range of 0.5 to 10 seconds, more preferably within a range of 0.5 to 7 seconds, and most preferably within a range of 1 to 5 seconds. In the present invention, “pushing time” means a time where the transparent film comes into contact with the printing cylinder.

When the pushing time is 0.5 seconds or more, absorbance of an organic solvent into the primer layer 2 will be sufficient, and the viscosity of the catalytic ink filled in the grooves 12 of the printing cylinder 11 increases. Accordingly, deficiency such as cobwebbing hardly occurs, and an excellent printing shape can be obtained. On the other hand, when the pushing time is 10 seconds or less, the organic solvent will not be excessively absorbed into the primer layer 2. The viscosity of the catalyst ink will not be excessively increased, and difficulty in transferring the transparent film “F” can be prevented.

The maximum value of the pushing pressure is preferably within a range of 10 N to 500 N, and more preferably within a range of 100 N to 300 N.

Then, the catalyst ink “C” may be coated onto the printing cylinder 11 with the dispenser 13, and an unnecessary portion of the catalyst ink “C” other than that present in the pattern grooves 12 may be removed with the blade 14. The shape of the blade, the material for the blade, and the number of blades included therein can be appropriately selected according to necessity.

The transparent film “F” is moved rotationally around the printing cylinder 11 while pushing the transparent film “F” onto the printing cylinder 11 with backup rolls 15 and 16, whereby the transparent film “F” is rotationally moved where the primer layer 2 of the transparent film “F” remained pushed onto the catalyst ink “C” on the printing cylinder 11 for a predetermined time.

Then, the transparent film “F” is released from between the roll and the printing cylinder with a backup roll 16, and the transparent film “F” is separated from the printing cylinder 11 to transfer the catalyst ink “C” on the printing cylinder 11 onto the primer layer 2 of the transparent film “F”.

Then, the transparent film “F” is dried with a drying device or the like according to necessity, and a dried catalyst ink layer 3 is obtained. The drying process may be preferably conducted at 100° C. or less in terms of the heat resistance of the transparent film “F” or to prevent cracks from being generated in the transferred film of the catalyst ink “C” during the drying process.

In this way, the catalyst ink layer 3 having a predetermined pattern can be formed on the primer layer 2 of the transparent film “F” by the gravure printing.

Thus, by use of the coating material for forming a primer layer having the above-described composition, and the catalyst ink, the “gravure direct printing method” can be conducted. According to the “gravure direct printing method”, excellent transfer properties and transfer efficiency can be achieved, and the catalyst ink “C” is transferred from the printing cylinder 11 directly onto the transparent film “F” without using a conventional transfer sheet (blanket).

According to such a direct printing method, a blanket, which is required in conventional methods, is unnecessary. In the present invention, by using the printing cylinder 11 which is cylinder-shaped, an endless impression can be achieved (i.e. by use of a impression cylinder).

Moreover, if such a printing cylinder 11 is used, the printing cylinder 11 can be produced by mask-less direct writing. Furthermore, by adjusting the depth of the pattern grooves, a thicker film can be printed, compared to gravure printing using a blanket, and the total amount of the catalyst increases due to the thickness of the catalyst ink, thereby facilitating deposition in plating. The thickness of the catalyst ink layer is preferably within a range of 0.1 μm to 10 μm, and more preferably within a range of 1 μm to 5 μm. The diameter of the printing cylinder of the present invention can be appropriately selected according to necessity. Therefore, a preferable diameter may be selected depending on conditions of the transparent film and the ink used therein. When a printing cylinder having an appropriate diameter or width, even a large-size transparent substrate with an electromagnetic wave-shielding film can be easily produced in the present invention.

The transparent film “F” is pushed onto the printing cylinder 11 for a predetermined time whereby the solvent present in the catalyst ink filled in the pattern grooves 12 is absorbed into the primer layer 2 which is a receptive layer. Accordingly, viscosity of the catalyst ink suddenly increases, the catalyst ink filled in the pattern grooves 12 can be transferred onto the transparent film “F” while maintaining the image shape in the printing plate. The pushing time can be controlled, and uniform transfer can be achieved.

Furthermore, the solvent absorbed into the primer layer 2 once dissolves the resin of the surface of the primer layer 2, and this is dissolved with the catalyst ink in the boundary. Consequently, adherence strength between the dried transparent film “F” and the catalyst ink layer 3 will be enhanced. Thus, a fine pattern can be printed at high speed (specifically, a fine pattern whose line width “L” is about 10 μm to 20 μm can be printed at about 10 m/minute while maintaining the designed image shape). Additionally, the printing speed is not limited in the present invention. However, the printing speed may be generally within a range of 5 to 30 m/minute, preferably within a range of 5 to 20 m/minute, and more preferably within a range of 5 to 15 m/minute.

Hereinafter, FIG. 4 will be described.

In the apparatus for producing a transparent substrate with an electromagnetic wave-shielding film of the present invention, a first blade and a second blade may be included as the blade 14. After the above-mentioned unnecessary portion of the catalyst ink may be removed with the first blade, the remaining portion of the catalyst ink may be further removed with the second blade.

In the apparatus for producing a transparent substrate with an electromagnetic wave-shielding film, the above-mentioned unnecessary portion of the catalyst ink is removed with the first blade, and then, the remaining portion of the catalyst ink is further removed with the second blade. Accordingly, the pattern resolution of the catalyst ink layer transferred onto the underlying layer will be further improved.

FIG. 4 is a schematic diagram showing an example of the apparatus for producing a transparent substrate with an electromagnetic wave-shielding film of the present invention, including a first blade and a second blade. With regard to differences between the apparatuses for producing a transparent substrate with an electromagnetic wave-shielding film shown in FIGS. 3 and 4, the production apparatus of FIG. 4 has a configuration where a blade 21 (the second blade) is provided parallel to a blade 14 downstream of the blade 14, the unnecessary portion of the catalyst ink “C” other than that present in the pattern grooves 12 is removed with the blade 14, and then, the remaining portion of the catalyst ink “C” is further removed with the blade 21.

The production apparatus can bring about the same effects as the production apparatus of FIG. 3. Furthermore, the unnecessary portion of the coated catalyst ink “C” other than that present in the pattern grooves 12 is removed by using blades 14 and 21. Therefore, resolution of the pattern of the catalyst ink transferred onto the primer layer 2 can be further improved.

### [Formation of Metal Layer]

The transparent film “F” where the catalyst ink layer 3 is formed may be soaked in a plating bath (for example, in an electroless copper or nickel plating bath), and the metal is deposited on the catalyst ink layer 3 to form a metal layer 4. Types of plating is not particularly limited. However, copper, nickel, gold or the like can be used.

Furthermore, if it is required to produce a mesh film having low resistance, a metal layer 4 may be provided on the catalyst ink layer 3 by electroless plating, and may be further subjected to copper electroplating. Additionally, after it is confirmed that a predetermined resistance value is obtained, black plating can be conducted. A type of black plating that does not deteriorate the electric conductivity of the copper-plated surface is preferable. For example, black nickel plating, black chromium plating, nickel-tin alloy plating or the like can be mentioned.

Such black plating can simultaneously color three planes of the front surface and the side surfaces of the mesh film black, and hardly impairs electric conductivity.

On the other hand, the mesh portion of the backside of the catalyst ink layer 3 is also favorably black-colored because of the black pigment included in the catalyst ink. Consequently, four planes, namely the front surface, the side surfaces and the backside surface of the mesh film, can be blackened. Therefore, excellent contrast can be achieved when the transparent substrate with an electromagnetic wave-shielding film is attached to a display.

As described above, even a transparent substrate with an electromagnetic wave-shielding film that has high electric conductivity, excellent transparency, and excellent black properties of the mesh-like pattern can be produced in a short and cost-effective production process.

The surface resistance of the transparent substrate with an electromagnetic wave-shielding film produced in the present invention is generally within a range of 0.02Ω/□ to 20Ω/□, and preferably within a range of 0.05Ω/□ to 0.2Ω/□. The visible-light transmittance thereof is generally within a range of 70% to 90%, and preferably within a range of 80% to 90%.

### EXAMPLES

Hereinafter, the present invention will be described with reference to Examples and Comparative Examples. However, the present invention is not limited to Examples.

### Example 1

### Preparation of a Coating Material for Forming a Primer Layer and Formation of the Primer Layer

240 g of alumina powder and 28 g of a phosphoester-based dispersing agent were charged into 1332 g of toluene, and this was dispersed with a sand mill to prepare an alumina-dispersed solution.

Then, 240 g of ethyl cellulose was dissolved in 1808 g of toluene. To this solution were added the above-prepared alumina-dispersed solution, 552 g of cyclohexanone, and 1800 g of methyl ethyl ketone (MEK). These were mixed with a homogenizer, thereby preparing a coating material for forming a primer layer.

Then, the coating material for forming a primer layer was coated onto a polyethylene terephthalate (PET) film 125 μm thick by micro-gravure printing. After that, this was dried to obtain a transparent film. The produced primer layer has a thickness of 2 μm.

### Preparation of a Catalyst Ink and Formation of a Catalyst Ink Layer

3.5 g of fine particles of palladium and 171.5 g of γ-alumina were dispersed and aggregated in ethanol, and this was subjected to solid-liquid separation. Then, this was dried, and fine particles of γ-alumina carrying fine particles of palladium were obtained.

Then, 90 g of ethyl cellulose was dissolved in a solution of 472 g of α-terpineol and 236 g of butyl carbitol acetate. The above fine particles of γ-alumina carrying fine particles of palladium, and 9 g of carbon black were added thereto, and these were mixed and dispersed with a triple roll mill to prepare a catalyst ink.

Using this catalyst ink and the above-described transparent film, a mesh pattern where L/S=20/280 μm was gravure-printed on a transparent film at a printing speed of 10 m/minute and for a pushing time of two seconds with an apparatus shown in FIG. 3, and this was dried at 80° C. for five minutes, thereby obtaining a printing mesh film. The shape of the produced mesh pattern was excellent, and any faults were not present in the external appearance. Additionally, with regard to evaluation on appearance of the film, when the film was uniform having no stripes or other irregularities, it was evaluated as “excellent”.

### Formation of a Metal Layer

The above printing mesh film was soaked in electroless copper plating solution “OPC-750” (produced by Okuno chemical Industries Co., Ltd.) at 25° C. for forty minutes to deposit copper on the mesh pattern. After that, this was further subjected to nickel/tin alloy plating, thereby blackening the surface of the mesh pattern. With respect to the produced mesh film, L/S=20/280 μm; the surface resistance was 0.2Ω/□; and the visible-light transmittance was 84%.

The measurement of the surface resistance was conducted at room temperature and at normal pressure using a “Loresta” (a four-terminal resistance meter produced Mitsubishi Chemical Corporation).

The measurement of the visible-light transmittance was conducted at room temperature and at normal pressure with a haze meter.

### Example 2

A printing mesh film was produced in the same manner as Example 1 except that zirconia powder was used instead of alumina powder. The shape of the produced mesh pattern was excellent, and any faults were not present in the external appearance.

Then, the printing mesh film was subjected to plating treatment in the same manner as Example 1 to produce a metal mesh film.

With regard to the produced metal mesh film, L/S=20/230 μm; the surface resistance was 0.2Ω/□; and the visible-light transmittance was 84%.

### Example 3

A printing mesh film was produced in the same manner as Example 1 except that silica powder was used instead of alumina powder. The shape of the produced mesh pattern was excellent, and any faults were not present in the external appearance.

Then, the printing mesh film was subjected to plating treatment in the same manner as Example 1 to produce a metal mesh film.

With regard to the produced metal mesh film, L/S=20/230 μm; the surface resistance was 0.2Ω/□; and the visible-light transmittance was 84%.

### Example 4

A printing mesh film was produced in the same manner as Example 1. The shape of the produced mesh pattern was excellent, and any faults were not present in the external appearance.

Then, the printing mesh film was soaked in an electroless copper plating solution “OPC-750” (produced by Okuno chemical Industries Co., Ltd.) at 25° C. for ten minutes to deposit copper on the mesh pattern.

Then, copper-deposited printing mesh film was subjected to copper electroplating treatment at a current density of 3 A/dm² and at 25° C. for five minutes using a copper electroplating solution “TOP LUCINA SF” (produced by Okuno Chemical Industries Co., Ltd). After that, this was further subjected to nickel/tin alloy plating, thereby blackening the surface of the mesh pattern. With respect to the produced mesh film, L/S=20/280 μm; the surface resistance was 0.05Ω/□; and the visible-light transmittance was 84%.

### Example 5

A transparent film was produced in the same manner as Example 1.

Then, a catalyst ink was produced in the same manner as Example 1 except that zirconia power was used instead of alumina powder included in the catalyst ink.

Using this catalyst ink, a mesh pattern where L/S=10/290 μm was gravure-printed on a transparent film at a printing speed of 20 m/minute with an apparatus shown in FIG. 3, and this was dried at 80° C. for five minutes, thereby obtaining a printing mesh film. The shape of the produced mesh pattern was excellent, and any faults were not present in the external appearance.

Then, this was subjected to plating treatment in the same manner as Example 4.

With respect to the produced metal mesh film, L/S=10/290 μm; the surface resistance was 0.1Ω/□; and the visible-light transmittance was 90%.

### Comparative Example 1

### Preparation of a Coating Material for Forming a Primer Layer and Formation of a Primer Layer

240 g of alumina powder, and 28 g of a phosphoester-based dispersing agent were charged into 1332 g of toluene, and this was dispersed with a sand mill to prepare an alumina-dispersed solution.

Then, 240 g of ethyl cellulose was dissolved in 1808 g of toluene. To this solution were added the above-prepared alumina-dispersed solution, 552 g of cyclohexanone, and 1800 g of methyl ethyl ketone (MEK). These were mixed with a homogenizer, thereby preparing a coating material for forming a primer layer.

Then, the coating material for forming a primer layer was coated onto a polyethylene terephthalate (PET) film 125 μm thick by micro-gravure printing. After that, this was dried to obtain a transparent film. The produced primer layer has a thickness of 2 μm.

### Preparation of a Catalyst Ink and Formation of a Catalyst Ink Layer

3.5 g of fine particles of palladium and 171.5 g of γ-alumina were dispersed and aggregated in ethanol, and this was subjected to solid-liquid separation. Then, this was dried, and fine particles of γ-alumina carrying fine particles of palladium were obtained.

Then, 90 g of ethyl cellulose was dissolved in a solution of 472 g of α-terpineol and 236 g of butyl carbitol acetate. The above fine particles of γ-alumina carrying fine particles of palladium, and 9 g of carbon black were added thereto, and these were mixed and dispersed with a triple roll mill to prepare a catalyst ink.

Using this catalyst ink and the above-described transparent film, a mesh pattern where L/S=20/280 μm, the same as Example 1, was printed on a transparent film by a screen printing method. This was dried at 90° C. for ten minutes. In addition, continuous processing as described in Example 1 could not be conducted. Accordingly, the maximum limit of the printing speed where an excellent mesh pattern shape could be achieved was 1 m/minute.

### Formation of a Metal Layer

The above printing mesh film was soaked in electroless copper plating solution “OPC-750” (produced by Okuno chemical Industries Co., Ltd.) at 25° C. for forty minutes to deposit copper on the mesh pattern. After that, this was further subjected to nickel/tin alloy plating, thereby blackening the surface of the mesh pattern. With respect to the produced mesh film, L/S=20/280 μm; the surface resistance was 0.2Ω/□; and the visible-light transmittance was 84%.

### Comparative Example 2

A transparent film and a catalyst ink were prepared in the same manner as Comparative Example 1.

Then, using the catalyst ink and the transparent film, a mesh pattern where L/S=20/280 μm was printed on a transparent film at a printing speed of 10 m/minute by a gravure printing method wherein backup rollers were not provided (i.e. a pushing time in the present invention was not set). This was dried at 80° C. for five minutes. The produced printing mesh film did not have a sufficient mesh pattern, and there were defects in the external appearance.

Then, a metal layer was formed in the same manner as Comparative Example 1. However, the shape of the printing mesh was inferior, and external defects that occurred in printing were also confirmed in the plated printing mesh film. The surface resistance was 0.2Ω/□; and the visible-light transmittance was 80%.

### Comparative Example 3

### Preparation of a Catalyst Ink

3.5 g of fine particles of palladium and 171.5 g of γ-alumina were dispersed and aggregated in ethanol, and this was subjected to solid-liquid separation. Then, this was dried, and fine particles of γ-alumina carrying fine particles of palladium were obtained.

Then, 90 g of ethyl cellulose was dissolved in a solution of 472 g of α-terpineol and 236 g of butyl carbitol acetate. The above fine particles of γ-alumina carrying fine particles of palladium, and 9 g of carbon black were added thereto, and these were mixed and dispersed with a triple roll mill to prepare a catalyst ink.

### Formation of a Catalyst Ink Layer

Using this catalyst ink, a mesh pattern where L/S=20/280 μm was gravure-printed directly on a polyethylene terephthalate film 125 μm thick at a printing speed of 10 m/minute with an apparatus shown in FIG. 3, and this was dried at 80° C. for five minutes. The produced printing mesh film did not have a sufficient mesh pattern, and there were defects in the external appearance.

Then, a metal layer was formed in the same manner as Comparative Example 1. However, the shape of the printing mesh was inferior, and external defects that occurred in printing were confirmed also in the plated printing mesh film. The surface resistance was 0.2Ω/□; and the visible-light transmittance was 70%.

### INDUSTRIAL APPLICABILITY

The present invention can provide a transparent substrate with an electromagnetic wave-shielding film having high electric conductivity and excellent transparency, wherein high accurate patterning can be achieved by a short and cost-effective process, a production method thereof and a production apparatus. The transparent substrate with an electromagnetic wave-shielding film adopts a gravure printing method as its printing system, and the underlying layer on the transparent substrate is pushed into the catalyst ink on the printing cylinder for gravure printing for a predetermined time whereby an electromagnetic wave-shielding film having a high-resolution pattern can be formed on the transparent substrate at a low cost. The transparent substrate with an electromagnetic wave-shielding film can be applied to not only typical flat panel displays (FPD) such as plasma display panels (PDP) but also the other display devices. Therefore, the present invention has high industrial value.

1. A transparent substrate with an electromagnetic wave-shielding film, comprising:
an underlying layer;
a catalyst ink layer having a predetermined pattern; and
a metal layer having the same shape as the pattern
that are laminated in this order on a transparent substrate having flexibility, wherein the catalyst ink layer is an ink layer where the catalyst ink is transferred on the underlying layer by pushing the underlying layer on the transparent substrate against a catalyst ink on a printing cylinder for gravure printing.

2. A method of producing a transparent substrate with an electromagnetic wave-shielding film, the method comprising:
coating a catalyst ink onto a printing cylinder for gravure printing where a predetermined pattern is formed;
keeping the catalyst ink on the printing cylinder being pressed against an underlying layer formed on a transparent film having flexibility for a predetermined time;
after pressing, separating the transparent substrate from the printing cylinder to transfer the catalyst ink on the printing cylinder onto the underlying layer on the transparent substrate; and
providing on the catalyst ink layer having a predetermined pattern a metal layer having the same shape as the pattern to produce the transparent substrate with an electromagnetic wave-shielding film, including the underlying layer, the catalyst ink layer having the predetermined pattern, and the metal layer having the same shape as the pattern that are laminated in this order on the transparent substrate having flexibility.

3. An apparatus for producing a transparent substrate with an electromagnetic wave-shielding film which is an apparatus for producing a transparent substrate with an electromagnetic wave-shielding film, including an underlying layer, a catalyst ink layer having a predetermined pattern, and a metal layer having the same shape as the pattern that are laminated in this order on a transparent substrate having flexibility, the apparatus comprising:
a printing cylinder for gravure printing having a predetermined pattern groove on the surface;
a dispenser that coats a catalyst ink onto the printing cylinder;
a blade that removes an unnecessary portion of the ink other than the ink included inside the pattern groove with respect to the coated catalyst ink;
a device that keeps the underlying layer on the transparent substrate being pressed against the printing cylinder, in which the catalyst ink is included in the pattern groove, for a predetermined time; and
a device which separates the transparent substrate from the printing cylinder after pressing to transfer the catalyst ink onto the underlying layer.

4. The apparatus for producing a transparent substrate with an electromagnetic wave-shielding film according to claim 3, wherein a pair of rolls for pressing the transparent substrate against the printing cylinder are provided as the device, the rolls are provided parallel to the printing cylinder where there is a space between the rolls, and a time where the transparent substrate is pressed against the printing cylinder is controlled by adjusting the positions of the rolls.

5. The apparatus for producing a transparent substrate with an electromagnetic wave-shielding film according to claim 3, wherein the blade includes a first blade and a second blade, the first blade removes the unnecessary portion of the catalyst ink, and the second blade further removes the unnecessary portion of the catalyst ink.

6. The transparent substrate with an electromagnetic wave-shielding film according to claim 1, wherein the predetermined time is within a range of 0.5 seconds to 10 seconds.

7. The transparent substrate with an electromagnetic wave-shielding film according to claim 1, wherein the catalyst ink includes fine particles of an oxide carrying fine particles of a precious metal; a black pigment; and an organic polymer.

8. The transparent substrate with an electromagnetic wave-shielding film according to claim 1, wherein the viscosity of the catalyst ink is within a range of 1 Pa·s to 500 Pa·s.

9. The transparent substrate with an electromagnetic wave-shielding film according to claim 7, wherein the precious metal is at least one selected from the group consisting of palladium, platinum and gold, and the fine particles of an oxide is at least one selected from the group consisting of fine particles of a metal oxide of alumina, zinc oxide, zirconia or titania.

10. The transparent substrate with an electromagnetic wave-shielding film according to claim 1, wherein the metal layer is a metal layer having a monolayer structure of an electroless copper-plated layer or an electroless nickel-plated layer; or a metal layer having a two-layer structure where one black plated layer selected from the group consisting of a black nickel-plated layer, a black chromium-plated layer, and a nickel-tin alloy-plated layer is formed on a copper-electroplated layer.
